(19) United States
(12) Patent Application Publication
(10) Pub. No.: US 2010/0049497 A1
(43) Pub. Date: Feb. 25, 2010

(54) PHONETIC NATURAL LANGUAGE TRANSLATION SYSTEM

(76) Inventor: Johnson ("Johnson") Manuel-Devadoss ("Smith"), Chennai (IN)

Correspondence Address: Johnson Manuel-Devadoss ("Johnson Smith"), Suite 03-276B, 4100 Clinton Drive, #03-276B, Houston, TX, 77020, US

(21) Appl. No.: 12/563,123

(22) Filed: Sep. 19, 2009

(51) Int. Cl. G06F 17/28; G06F 17/20; G10L 13/08; G10L 15/00

(52) U.S. Cl. 704/3; 704/8; 704/260; 704/231; 704/E15.003; 704/E13.001

(57) ABSTRACT

The phonetic natural language translation system receives audio output from an electro acoustic device connected as a component in an audio system presented in a theater or auditorium, to identify any speech signal contained within the audio output. The speech signals are broken down into recognizable phonemes. The sequentially generated phonemes are then regrouped to form recognizable words in one of the 6,700 languages spoken around the world. Sentences are then formed using the grammatical rules of the recognized language so that each sentence translated into each of the audience's preferred language without any external translators. The preferred language of each audience is identified during ticket booking; an algorithm stores the audience seat number along with preferred language. The translated audio signals are distributed to an each seat's armrest such that each viewer listens and understands the foreign language audible program or speech in their own preferred language.

The phonetic natural language translation system receives audio output from an electro acoustic device that is connected as a component in an audio system presented in a theater or auditorium, so as to identify any speech signal contained within the audio output. The speech signals are broken down into recognizable phonemes which make up the most basic elements of speech in spoken languages. The sequentially generated phonemes identified from the speech signals are then regrouped so as to form recognizable words in one of a language in 6,700 languages that are spoken around the world. Sentences are then formed using the grammatical rules of the recognized language so that each sentence translated into each of the individual audience's preferred language, where audiences are the group of people prefers to listen to foreign language audible program or any foreign language speech in their own preferred language without any external translators. The preferred language of each audience is identified during ticket booking; an algorithm stores the audience seat number along with preferred language. The translated audio signals are distributed to an each seat's armrest such that each viewer listens and understands the audible speech of foreign language films or foreign language speech in their own preferred language inside a room or hall, fitted with tiers of seats rising like steps.

### FIELD OF THE INVENTION

The present invention relates generally to a natural language translating system, and more particularly, to a Phonetic Natural Language Translating System capable of translating an audible sound from the any audio output device to a plurality of audience's preferred language.

### BACKGROUND OF THE INVENTION

In recent times, the number of people watching international movies for the purpose of pleasure and/or entertainment is reduced because of language barrier. Foreign films can be a pleasurable viewing experience except for language comprehension. People in different parts of the region generally prefer to watch movies or events in different languages. During watching such a movies or events, an audience may find it hard to comprehend the language of audible program.

In order to overcome such comprehension problems, an audience may use a human interpreter, closely look for movie subtitle and read through or a combination of similar tools. However, human interpreters are usually very costly; and reading subtitle from motion movie is really hard and do not allow for speedy comprehension.

Because of language barrier foreign films are either dubbed or have subtitles. If the idea of ‘reading’ a movie turns user off, their only choice is to watch a dubbed version of the original movie in their preferred language. In order to dub the original movie from one foreign movie to another movie, it would take double the amount film making especially dubbing voice, songs re-recording.

In Film festivals, like Cannes, people would like to watch good foreign movies; especially they would like to know about how they used modern technologies, storyline, and screenplay on foreign movies. In terms of musical concerts, people would like to see foreign musical composer concerts. Due to language barrier, quality of music is not able to reach to people around the world

The following U.S. patents are hereby incorporated by reference for their teaching of language translation systems and methods: U.S. Pat. No. 6,356,865, issued to Franz et al., entitled “Method and apparatus for performing spoken language translation”; U.S. Pat. No. 5,758,023, issued to Bordeaux, entitled “Multi-language speech recognition system”; U.S. Pat. No. 5,293,584, issued to Brown et al., entitled “Speech recognition system for natural language translation”; U.S. Pat. No. 5,963,892, issued to Tanaka et al., entitled “Translation apparatus and method for facilitating speech input operation and obtaining correct translation thereof”; U.S. Pat. No. 7,162,412, issued to Yamada et al., entitled “Multilingual conversation assist system”; U.S. Pat. No. 6,917,920, issued to Koizumi et al., entitled “Speech translation device and computer readable medium”; U.S. Pat. No. 4,984,177/issued to Rondel et al., entitled “Voice language translators; and U.S. Pat. No. 4,507,750, issued to Frantz et al., entitled “Electronic apparatus from a host language”.

According to U.S. Pat. No. 5,615,301 issued to Rivers et al., entitled “Automated Language Translation System”, each sentence is translated into a universal language and then translates the sentences from universal language to the native language of the user as identified by the user. But a Phonetic Natural Language System of present invention uses the language dictionaries of 6,700 languages which contains all possible word and set of grammatical rules presented in 6,700 languages that are being used in 228 countries. Using 6,700 language dictionaries, a Phonetic Natural Language System of present invention translating an audible speech in one language directly to plurality of audience preferred languages and distribute to each audience's seat armrest audio output. Thus, audience may enjoy the audible program without holding any external language translation apparatus.

Accordingly, there is a need for a system for translation from audio output of any audio output device to a plurality of audience's desired language in a fast, easy, reliable and cost effective manner. Moreover, there is a need for a translating system that may substitute interpreters and subtitles.

### SUMMARY OF THE INVENTION

The Phonetic Natural Language Translation System is an ultimate goal of translating audio output from an electro acoustic device to each individual audience's preferred language and delivers the translated speech as an audio signal corresponding audience's seat armrest speaker. The present invention of Phonetic Natural Language Translation System has ability to understand interactions at the discourse knowledge level, predict next utterances, understand pronoun references, and provide high-level constraints for generating contextually appropriate sentences involving various context-dependent phenomena. The system accepts an audio output from electro acoustic device independent continuous-speech inputs through an instrument that is capable of transforming sound waves into electro-magnetic signals.

The present invention of Phonetic Natural Language Translation System accomplishes two major goals; one is translating the language of audible speech directly to each individual's preferred language of audience; and second delivers the translated audible speech in an each audience's preferred language to a corresponding audience seat armrest audio output.

In view of the foregoing disadvantages inherent in the prior art, the general purpose of the present invention is to provide a natural language translation system configured to include all the advantages of the prior art, and to overcome the drawbacks inherent therein.

Therefore, an object of the present invention is to provide the phonetic natural language system that is capable of providing a translation of audio output of an audible program from one language to each individual audience's preferred language, thereby audience can listen to the audible speech of foreign language program without using language interpreters or closely reading the subtitles of foreign language program.

The present invention also provides a user interface to the audience where he/she is able to select the preferred language to listen to the audible speech. The user interface of present invention provides the audience to know about promotional offers on ticket booking, Have provision for city-wise ticket booking, new releases, and enable audience to choose seats. The user interface is also available through the WAP enabled devices or at ticket booking kiosks.

This present invention discloses a speech recognition module which is capable of identifying phoneme-level sequences from audio output in highly accurate, real-time performance under speaker-independent, continuous speech, large-vocabulary conditions. The Speech recognition module receives electro-magnetic signals and provides the real-time output of phoneme sequences excluding unwanted noise and sends it to the translation module. The language translation module used for parsing and generation is being capable of interpreting the elliptical, ill-formed sentences that appear in the audio output of audio program. In addition an interface between the parser and speech recognition module must pass necessary information to the parser and give appropriate feedback to the speech recognition module to improve recognition accuracy. After translation a distribution algorithm associates the different translated audio signals with the audience seat and sends it to the distribution unit. This unit performs the final task of making the translated audio signal to each individual audience seat.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is the prior art of a phonetic natural language translation system, according to an embodiment of the present invention;

FIG. 2 illustrates a user interface for ticket booking and where audience selects their preferred language to view/listen the audible program;

FIG. 3 illustrates on how translated audio signals are being distributed to a plurality of audience seat's armrest audio output connector using distribution unit;

FIG. 4 illustrates an audience seat of the prior art;

FIG. 5 illustrates a process flow of a phonetic natural language translation system, according to an embodiment of the present invention.

### DETAILED DESCRIPTION

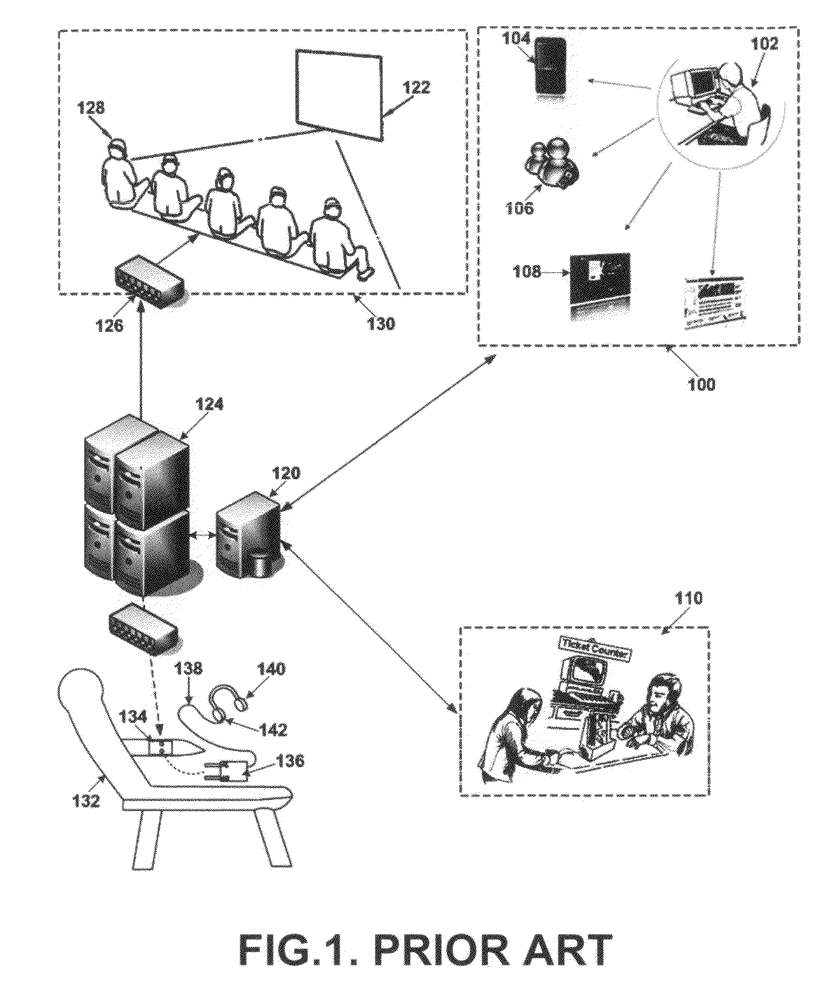

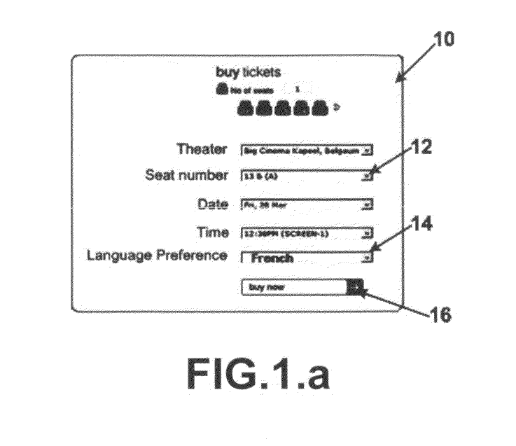

The present invention discloses an automated method to help the audiences to enjoy the public events like indoor area for housing dramatic presentations, stage entertainments, surgical demonstrations or motion-picture shows in their natural language. The Phonetic Natural Language Translation System of present invention includes an online ticket booking application to store the audience preferred language along with their seat number. In FIG. 1, an audience 102 books a ticket for a public event that is a dramatic presentation, stage entertainment, surgical demonstration or motion-picture show in foreign natural language. Audience 102 may uses their WAP enabled device 104, online device application 106 to book a ticket or uses third party vendor 108 to book a ticket for public events. The Phonetic Natural Language Translation System of the present invention provides an option to audience to choose the language to watch/listen the public events as shown in FIG. 1.a.

As shown in FIG. 1, a Phonetic Natural Language Translation System of the present invention provides an option to choose the audience preferred language while the audience is buying a ticket at ticket counter 120. The sales person asks the audience's preferred language to enter the language preference along with seat number to the system using a user interface. If there is no preferred language selected for a particular seat then the present invention chooses the default language i.e., “English” as the preferred language for a particular audience.

The Phonetic Natural Language Translation System of present invention includes a graphical user interface, audio output capture device as an input unit, natural language translation module, distribution unit, and output unit. Natural language translation module includes a speech recognition module, language translation module, voice synthesizer module, and distribution algorithm.

As shown in FIG. 1.a, a user interface 10 for ticket booking system of the present invention includes a graphical user interface element 14 which contains 6,700 natural language names used in 228 countries, allowing the audience to either type the preferred language name directly into the control or choose one of the natural language as preferred language from the list of existing options to enjoy the event. When audience clicks a “buy now” 16 button, the online application algorithm of a user interface constructs the two-dimensional hash table for a selected value of element 14 and seat number from element 12 where seat number from element 12 is a key and selected value of element 14 is a value. Online application algorithm of a user interface stores the two-dimensional hash table to ticket booking system database server 120 as shown in FIG. 1.

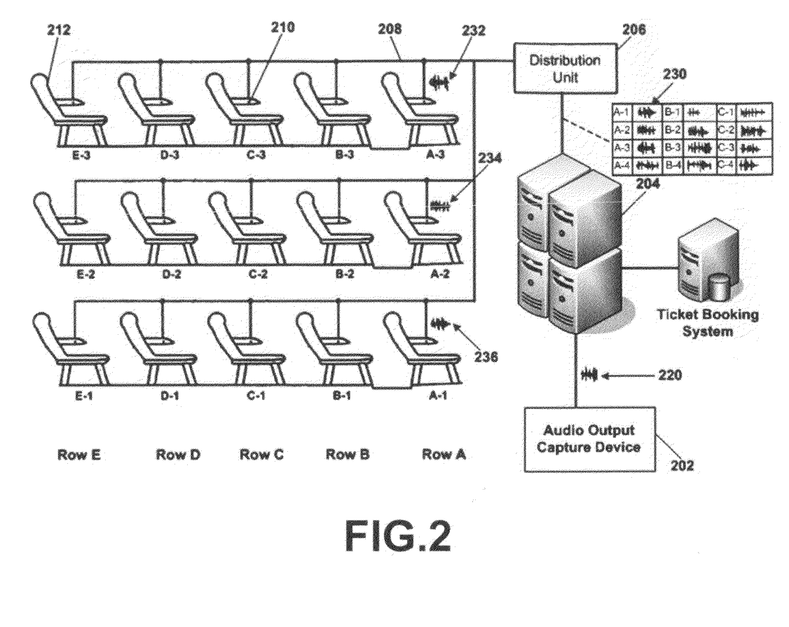

As shown in FIG. 2, an audio output capture device 202 is an instrument capable of transforming sound waves into electro-magnetic waves, i.e. Microphone, which is operatively couple to the Phonetic Natural Language Translation System of the present invention.

The natural language translation module includes a speech recognition module, parsing, generation, voice synthesizer, and distribution algorithm. Such a system is disclosed in “DM-Dialog: An Experimental Speech-to-Speech Dialog Translation System” by Hironki Kitano et al., IEEE journal 0018-9162/91/0600-003 made of record and incorporated herein by reference.

The natural language translation module of Phonetic Natural Language Translation System identifies the phoneme-level sequences from an audio output of an audible program, and builds the information content from best bet hypotheses of phoneme-level sequence using language dictionaries. The language dictionaries is a knowledge base which contains all possible word presented in 6,700 natural languages that are being used in 228 countries and provides lexical, phrase, syntactic fragment to generation module while generating the equivalent sentence of each preferred language of an audience for the audible speech from audio output.

A distribution algorithm of natural language translation module is closely integrated with distribution unit which provides a two-dimensional hash table of translated audio signal with corresponding seat number where hash table is a two-dimensional array that have a link format of seat number and translated audio signal, which allows distribution unit to deliver the audio signal based on seat number.

A distribution unit is operatively coupled to the present invention of Phonetic Natural Language Translation System discloses and connected to each seat's armrest female connector as shown in FIG. 2. A distribution unit receives a two-dimensional hash table 230 which contains analog audio signals for audible program presented to the audience, and then it transferred on a physical cabling distribution network 208 to each audience seat. The cabling distribution network from a distribution unit is placed within each theater room and a “female” type connector 210 placed in the audience seat armrest. A “male” plug connector is inserted into the female connector to make contact with the cabling distribution network to receive the analog audio signals. The male plug connector is connected to a cable which is connected to a set of headphones. The set of headphones has a left speaker and a right speaker that are placed respectively on the left and right ears of an audience for listening to the analog audio signal.

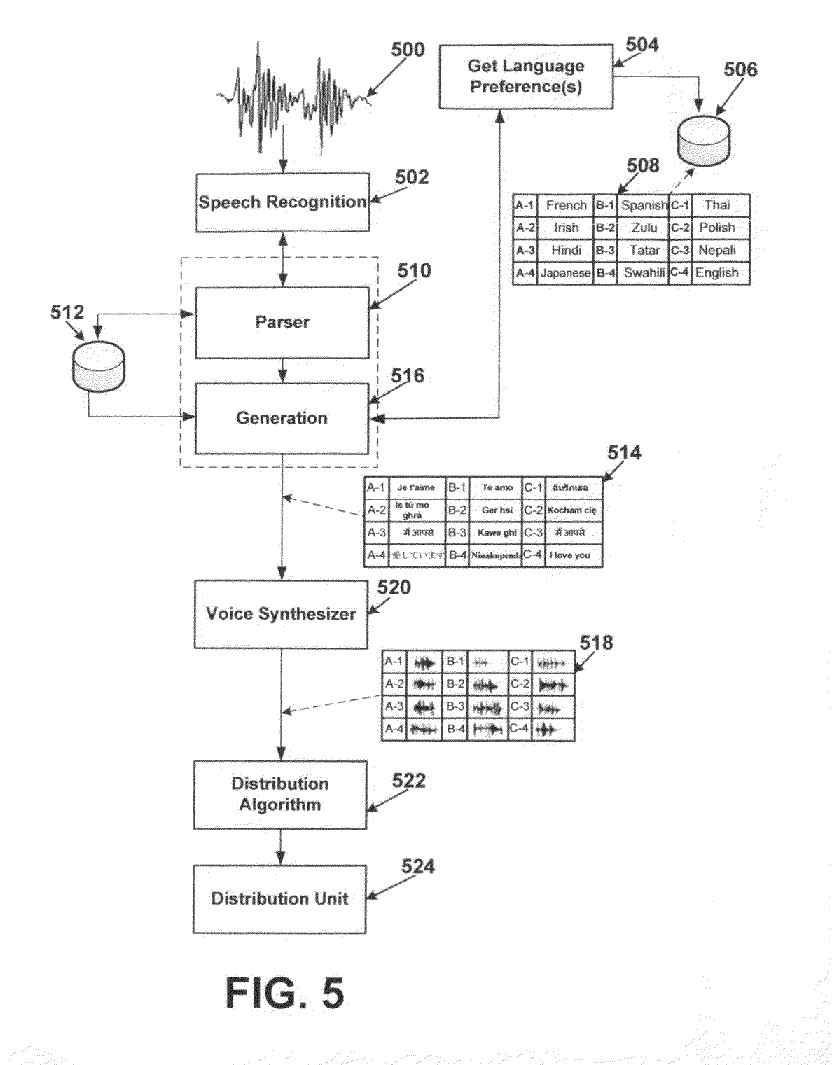

The natural language translation module of Phonetic Natural Language Translation System operates as shown in FIG. 5. An audio output capture device 202 receives an audible output from an electro acoustic device that is connected as a component in an audio system of indoor area for housing dramatic presentations, stage entertainments, surgical demonstrations or motion-picture shows. As shown in FIG. 5, a speech reorganization module 502 identifies the phoneme-level sequences from an audio signal 500 and operatively coupled to the parser 510 where speech recognition module 502 receives the feedback of phoneme hypothesis and word hypothesis prediction from the parser. The accuracy of speech recognition improved by interface made between speech recognition module 502 and parser 510 because it filters out false first choices of the speech recognition module and selects grammatically and semantically plausible second or third best hypotheses. The parser 510 is capable of handling multiple hypotheses in a parallel rather than a single word sequence as seen in text input machine translation systems. The phoneme sequence contains substitution, insertion and deletion of phonemes, as compared to a correct transcription which contains only expected phonemes, such a phoneme sequence a noisy phoneme sequence. The task of phonological-level processing of parser 510 is to activate a hypothesis as to the correct phoneme sequence from this noisy phoneme sequence. The parser 510 does the prediction of best hypothesis using language dictionaries 512 for phoneme and word hypothesis received from speech recognition module 502. Thus, best bet of hypotheses are chosen to build the informational content that is sentence of audible speech.

Simultaneously, the natural language translation module 204 receives a two-dimensional hash table 508 from online ticket booking database 506 which has each of an individual audience's preferred language associated with seat number. A generation module 516 is capable of generating appropriate sentences with correct articulation control. Generation module 516 produces a grammatical sentence for each an individual preferred language which is defined in a hash table 508, by using a set of grammatical rules defined in language dictionaries. The present invention of Phonetic Natural language Translation System employs a parallel incremental generation scheme, and a generation process and the parsing processing run almost concurrently. Thus, a part of the utterance may be generated while parsing is in progress. The present invention adopts common computation principles in both parsing and generation, and thus allows integration of these processes. Almost concurrent parsing and generation: Unlike traditional methods of machine translation in which a generation process is invoked after parsing is completed, this invention concurrently executes the generation process during parsing. Both the parsing and generation processes employ parallel incremental algorithms. This enables Multimedia Native Language Translation System to generate a part of the input utterance during the parsing of the rest of the utterance. Thus, the audible speech sentence is being translated to multiple natural languages, and then provides a hash table of generated sentences 514 to Voice synthesizer 520. Voice synthesizer module 520 provides audio signals for translated sentences as hash table 518 to the distribution algorithm 522.

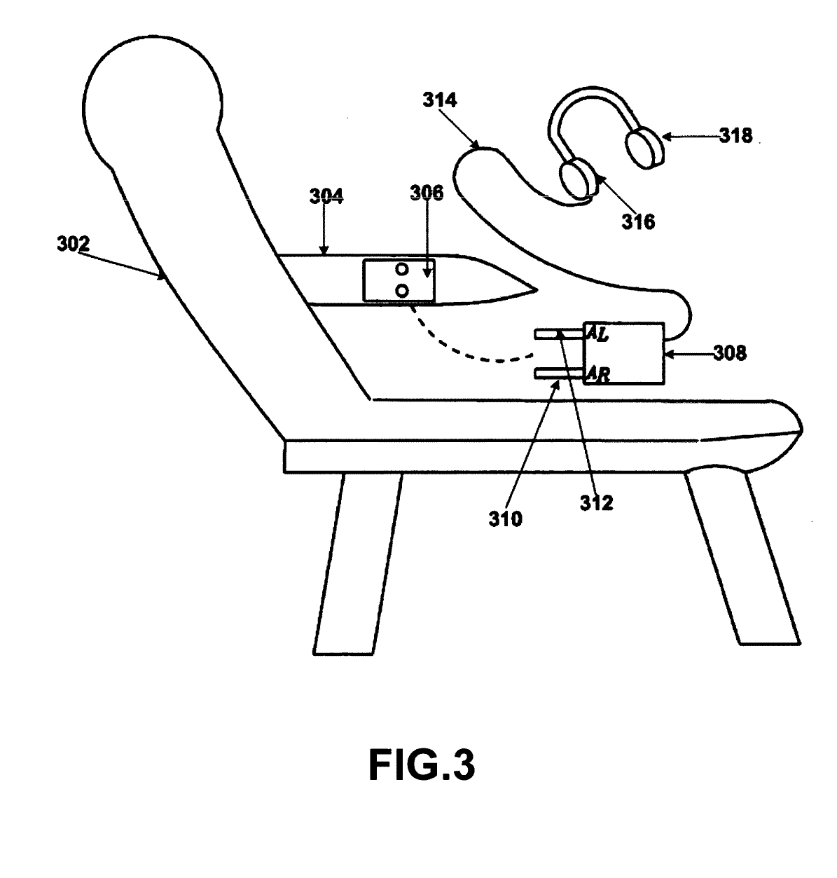

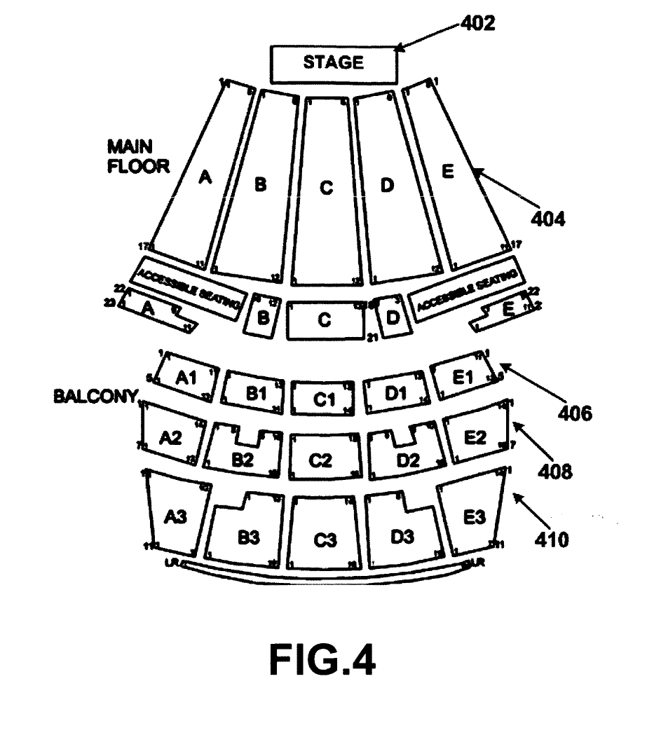

A distribution algorithm 522 is operatively coupled to the distribution unit 524 which uses a hash function to efficiently map seat number to associated audio signal of each an individual audience's preferred language. The hash function is used to transform the seat number into the index of the theater 130 or an auditorium (as shown in FIG. 4) seat (as shown in FIG. 3) where the corresponding preferred language audio signal is to be sought.

As shown in FIG. 2, the distribution apparatus receives an array of audio signals with seat number. Distribution unit uses a hash function to retrieve the audio signals for armrest connectors of seat in an each Row of an auditorium or the theater. As shown in FIG. 2, distribution unit retrieves the audio signals 232, 234, 236 from natural language translation module output for the A-1, A-2, A-3 seats' armrest connector in a Row A.

As shown in FIG. 3, a Phonetic Natural Language Translation System of the present invention includes a chair where a viewer or listener is sits to watch the audible program presented in the theater or an auditorium, usually having four legs for support and a rest for the back 302 and often having rests for the arms 304. A two-slot “female” type connector 306 placed in the audience seat armrest. A two-pin 310, 312 “male” plug connector 308 is inserted into the female connector to make contact with the cabling distribution network to receive the analog audio signals. The male plug connector is connected to a cable 314 which is connected to a set of headphones. The set of headphones has a left speaker 316 and a right speaker 318 that are placed respectively on the left and right ears of an audience for listening to the analog audio signal.

Although the description above contains many specificities, these should not be construed as limiting the scope of the invention but as merely providing illustrations of some of the presently preferred embodiments of the invention. For example, the translation system of the present invention could be utilized in any public event place where audible program speech is being broadcasted to each of audience's preferred language. Such public event place could be, for example, a theater, an auditorium, an flight, and such audible program could be, for example, an indoor area for housing dramatic presentation, a stage entertainment, a surgical demonstration, in-flight entertainment/announcements or a motion-picture show having a sound track.

I claim:

1. A language translation system operatively coupled to an audio output of an electro acoustic device that is connected to the audio system, for presenting an audible program to a plurality of audience, said language translation system translating the program audibly into each audience's preferred language, said language translation system comprising:
an audio input connectable to an audio output of said electro acoustic device; speech recognition module operatively coupled to said audio input for converting any speech within the audio output of the said electronic device into recognizable phonemes; translation module operatively coupled to said speech recognition module for grouping the recognized phonemes into recognizable words and sentences in a recognizable natural language so as to translate said recognizable sentences from said natural language directly into a plurality of target languages, said target language translation module further having a plurality of outputs; a system allowing each user to select one of said plurality of target languages; and a plurality of voice synthesizers connected to said outputs of said target language translation module so as to broadcast audible speech which is the translation of said program in said plurality of target language,
wherein said audience is listener or viewer at a public event, who do not use an external language translation apparatus to understand the audible program of unrecognizable natural language in a large room; wherein said large room is a room or hall, fitted with tiers of seats rising like steps;
wherein said the unrecognizable natural language is a language of speech which the audience not able to comprehend.

2. The language translation system according to claim 1, wherein the audible program is in an indoor area for housing dramatic presentations.

3. The language translation system of claim 1 which interfaces with an external system, such as an airline reservation system, to determines user preferences.

4. The language translation system according to claim 1, wherein the audible program is a stage entertainment.

5. The language translation system according to claim 1, wherein the audible program is a motion-picture show in a room or hall, fitted with tiers of seats rising like steps.

6. The language translation system according to claim 1, wherein the audible program is a surgical demonstration to the public said in a room or hall, fitted with tiers of seats rising like steps.

7. The language translation system according to claim 1, wherein said the large room is a theater.

8. The language translation system according to claim 1, wherein said the large room is an auditorium.

9. The language translation system according to claim 1, wherein said the preferred language may be a natural language chosen by said the audience while booking a ticket,
wherein said natural language belongs to a one of 6,700 natural languages which are used in 288 countries.

10. The language translation system according to claim 1, further comprising:
the language dictionaries containing all possible words and set of grammatical rules presented in 6,700 natural languages which are used in more than 228 countries;
a distribution algorithm provides an input to the distribution unit,
wherein said input contains a hash table of translated audio signal with seat number of the said audiences;
wherein said hash table is a two dimensional table that have a link format of seat number and said translated audio signal, which allows distribution unit to deliver the translated audio signal based on seat number;
wherein said translated audio signal is the translated audible speech as an audio signal in preferred language that is chosen by the audience during booking a ticket;
wherein said translated audible speech is the translated speech in audience's preferred language for an audio output from electro acoustic device that is connected in a room or hall, fitted with tiers of seats.
a distribution unit operatively coupled to said a distribution algorithm to distribute the said translated audio signal to each assigned seat's armrest connector,
wherein said a distribution unit connected to each said armrest connector of seat of said a large room to provide an said audible speech in audience's said preferred language,
wherein said armrest connector is a two-slot female connector which is a receptacle that connects to and holds the male connector.

11. The language translation system according to claim 1, further comprising an user interface to collect the said audience's preferred language, an user interface is comprising:
a graphical user interface element which contains 6,700 natural language names used in 228 countries, allowing the said audience to either type the said preferred language name directly into the control or choose one of the natural language as said preferred language from the list of existing options to enjoy the event;
an algorithm stores the said audience seat number along with said preferred language in a two dimensional said hash table;

12. The language translation system according to claim 1, contains an output unit operatively coupled to a said connector, to connect to a said female connector of said seat's armrest of a said large room, the output unit capable of outputting the translated audio speech to audience's seat armrest electro acoustic device,
wherein said connector is a two-pin male connector plugged to a said female connector integrated into said arm of a seat of said large room such that said audience listens an audible speech of his/her preferred language for an audio signal broadcast in the said large room.

13. A language translation system for the people who like to present the audio output of said an audible program from electro acoustic device that is connected to the audio system of a said large room, to each of an individual said audience's preferred language.

14. The language translation system of claim 13, wherein said people is the organizer of an event.

15. The language translation system of claim 13, wherein said people is the theater owner.

16. The language translation system of claim 13, wherein said people is the owner of an auditorium.
